(19) United States
(12) Patent Application Publication
(10) Pub. No.: US 2007/0100927 A1
(43) Pub. Date: May 3, 2007

(54) Wide tunable polyphase filter with variable resistor and variable capacitor

(75) Inventors: Eun Chul Park, Yongin-si (KR); Hoon Tae Kim, Yongin-si (KR); Choong-Yul Cha, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/397,777

(22) Filed: Apr. 5, 2006

(30) Foreign Application Priority Data
Nov. 3, 2005 (KR) 10-2005-0104815

(51) Int. Cl. G06G 7/02

(52) U.S. Cl. 708/819

(57) ABSTRACT

Disclosed is a wideband polyphase filter using variable resistors and variable capacitors for correcting a phase and a frequency to be suitable for wideband communication. There is provided a wideband polyphase filter including: a variable resistor in which resistance varies; and a variable capacitor in which capacitance varies, wherein the variable resistor and the variable capacitor correct a wideband frequency and a phase, converts a predetermined differential input into a quadrature signal and outputs the converted quadrature signal. A wideband polyphase filter which varies resistance and capacitance to correct a phase and frequency, and also may obtain a wideband frequency range may be provided.

### CROSS-REFERENCE TO RELATED APPLICATION

This application claims priority from Korean Patent Application No. 10-2005-104815, filed on Nov. 3, 2005, in the Korean Intellectual Property Office, the disclosure of which is incorporated herein by reference.

### BACKGROUND OF THE INVENTION

1. Field of the Invention

The present invention relates to a wideband polyphase filter for performing wideband communication, and more particularly, to a wideband polyphase filter using variable resistors and variable capacitors for correcting a phase and a frequency to be suitable for wideband communication.

2. Description of Related Art

FIG. 1 is a schematic diagram illustrating a configuration of a communication circuit using a polyphase filter.

Referring to FIG. 1, a low noise amplifier (LNA) 120 reduces noise of a signal received via an antenna 110 and amplifies the received signal. A mixer 130 receives and mixes a signal outputted from the LNA 120 and a signal outputted from a polyphase filter (PPF) 140. The PPF 140 receives a signal of a voltage control oscillator (VCO) 150, to directly convert a radio frequency (RF) signal into a baseband signal via the mixer 130. The PPF 140 generates a quadrature signal having a 90 degree phase difference from the RF signal. A low pass filter (LPF) 160 passes only a low signal from signals outputted from the mixer 130.

FIG. 2 is a diagram illustrating a configuration of a circuit of a conventional polyphase filter.

In the case of the conventional polyphase filter, the frequency tuning range of a resistor and a capacitor is limited. Accordingly, as illustrated in FIG. 2, the conventional polyphase filter has to be formed of multiple stages (stage 1 to stage n) of resistors (R11 to Rn4) and capacitors (C11 to Cn1), so as to be used in wideband communication. In this case, the conventional polyphase filter is capable of covering the band of a wideband frequency. However, the conventional polyphase filter for wideband communication has to compensate for attenuation of a signal, caused by passing through multiple stages of physical devices such as R11 to Rn4 and C11 to Cn1. Accordingly, power consumption increases and noise also occurs. Also, because of I/Q mismatch, in the conventional polyphase filter, a phase error of more than five degrees such as 85 degrees or 95 degrees with respect to a differential input of 0 degrees occurs.

U.S. patent application Ser. No. 6,538,498 discloses a Gm-C tuning circuit using a conventional polyphase filter. The conventional Gm-C tuning circuit has the characteristics of fixed capacitance and variable resistance, and tunes a frequency of a filter by controlling a GM cell. Namely, the conventional gm-C tuning circuit varies resistance by using an amplifier such as a GM cell. However, the frequency characteristic of the amplifier used as variable resistance is limited. Accordingly, the conventional Gm-C tuning circuit is not suitable for a high frequency such as an RF.

Korean Patent Registration No. 10-395213 relates to a quadrature signal generator and phase error correction method using a conventional polyphase filter. In this instance, a frequency is tuned by using fixed resistance and variable capacitance, but the range of the variable capacitance is small. Accordingly, this may not be tuned from an extremely low frequency to an extremely high frequency. Namely, in the quadrature signal generator and phase signal correction method using the conventional polyphase filter, the frequency tuning range is limited. Accordingly, it may not be applicable to wideband communication.

Consequently, a wideband communication polyphase filter capable of performing wideband communication, while reducing signal attenuation and also solving I/Q mismatch is desirable.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

It is an aspect of the present invention to provide a wideband polyphase filter which is suitable for wideband communication.

It is also an aspect of the present invention to provide a wideband polyphase filter which utilizes a minimum number of stages to reduce signal attenuation.

It is another aspect of the present invention to provide a wideband polyphase filter which corrects phase errors to solve I/Q mismatch.

Accordingly, an exemplary embodiment of the present invention provides a wideband polyphase filter including: a variable resistor in which resistance varies; and a variable capacitor in which capacitance varies, wherein the variable resistor and the variable capacitor correct a phase and a wideband frequency, converts a predetermined differential input into a quadrature signal and outputs the converted quadrature signal.

### BRIEF DESCRIPTION OF THE DRAWINGS

The above and/or other aspects of the present invention will become apparent and more readily appreciated from the following detailed description, taken in conjunction with the accompanying drawings in which:

FIG. 1 is a schematic diagram illustrating a configuration of a communication circuit using a polyphase filter;

FIG. 2 is a diagram illustrating a configuration of a circuit of a conventional polyphase filter;

FIG. 3 is a diagram illustrating a configuration of a circuit of a wideband polyphase filter according to an exemplary embodiment of the present invention;

FIG. 4 is a diagram illustrating a relationship between a control voltage and resistance, in a wideband polyphase filter according to an exemplary embodiment of the present invention;

FIG. 5 is a diagram illustrating a relationship between a control voltage and capacitance, in a wideband polyphase filter according to an exemplary embodiment of the present invention;

FIG. 6 is a diagram illustrating a relationship between an operating frequency and I/Q magnitude, in a wideband polyphase filter according to an exemplary embodiment of the present invention; and

FIG. 7 is a diagram illustrating relationship between an operating frequency and I/Q phase, in a wideband polyphase filter according to an exemplary embodiment of the present invention.

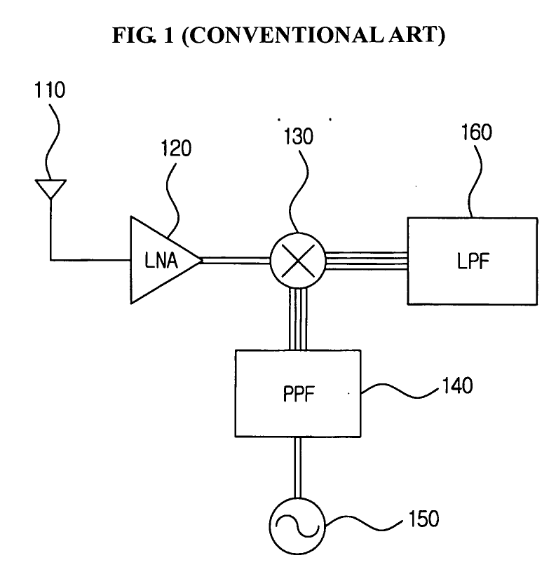

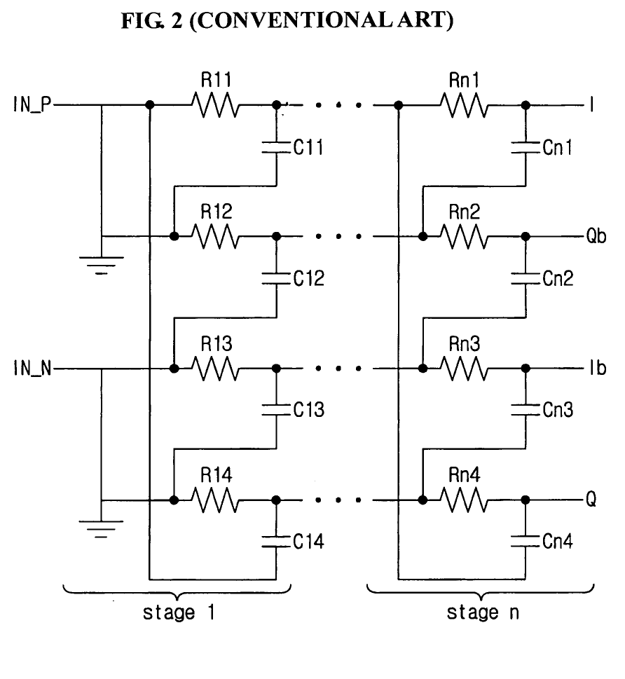

### DETAILED DESCRIPTION OF THE EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

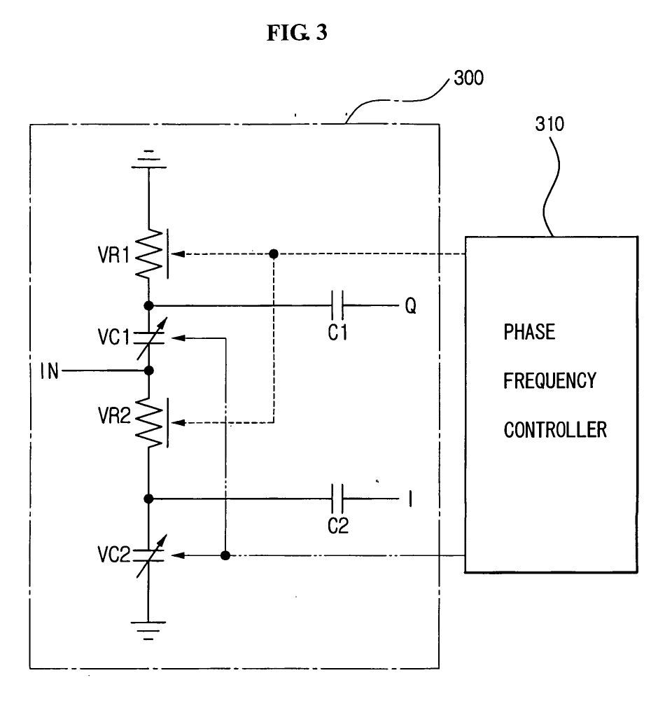

FIG. 3 is a diagram illustrating a configuration of a circuit of a wideband polyphase filter according to an exemplary embodiment of the present invention.

Referring to FIG. 3, a wideband polyphase filter 300 according to an exemplary embodiment of the present invention includes variable resistors VR1 and VR2 in which resistance varies, and variable capacitors VC1 and VC2 in which capacitance varies.

The wideband polyphase filter 300 according to an exemplary embodiment of the present invention may tune a desired wideband frequency by varying each resistance and capacitance to correct a phase and a frequency with respect to the variable resistors VR1 and VR2, and the variable capacitors VC1 and VC2.

Also, the variable resistors VR1 and VR2 and the variable capacitors VC1 and VC2 may correct a phase and a frequency, change a predetermined differential input IN into a quadrature signal and output the same.

Also, the variable resistors VR1 and VR2 and the variable capacitors VC1 and VC2 may be formed in a single-stage or multi-stage to tune a desired wideband frequency.

When the variable resistors VR1 and VR2 and the variable capacitors VC1 and VC2 are formed in multi-stage, the wideband polyphase filter 300 according to an exemplary embodiment of the present invention may be constructed as a filter formed with a minimum number of stages required. Such configuration reduces signal attenuation.

As illustrated in FIG. 3, the wideband polyphase filter 300, according to an exemplary embodiment of the present invention, is connected in order of a first variable resistor VR1, a first variable capacitor VC1, a second variable resistor VR2 and a second variable capacitor VC2.

One side of the first variable resistor VR1 is connected to a ground and the other side of the first variable resistor VR1 is connected to the first variable capacitor VC1.

The first variable resistor VR1 receives a control signal from a phase frequency controller 310 and varies resistance according to the received control signal. In this instance, the control signal is for correcting a phase and frequency of the first variable resistor VR1.

When an adjustment of a wideband frequency is needed or when a phase error such as an I/Q mismatch is detected by signals I and Q outputted from the wideband polyphase filter 300, the phase frequency controller 310 outputs a control signal for correcting a phase and frequency of the wideband polyphase filter 300.

Namely, when an error with respect to a phase of a signal outputted from the wideband polyphase signal 300 occurs or when adjustment of the wideband frequency is needed, the phase frequency controller 310 detects the above error or the need for an adjustment and outputs a control signal for correcting each of the phase and frequency via the variable resistors VR1 and VR2 and the variable capacitors VC1 and VC2 of the wideband polyphase filter 300.

Accordingly, the wideband polyphase filter 300 according to an exemplary embodiment of the present invention may receive a control signal from the phase frequency controller 310 and vary resistance of the variable resistors VR1 and VR2 and capacitance of the variable capacitors VC1 and VC2 according to each received control signal. In this manner, the phase and frequency of the wideband polyphase filter 300 may be corrected.

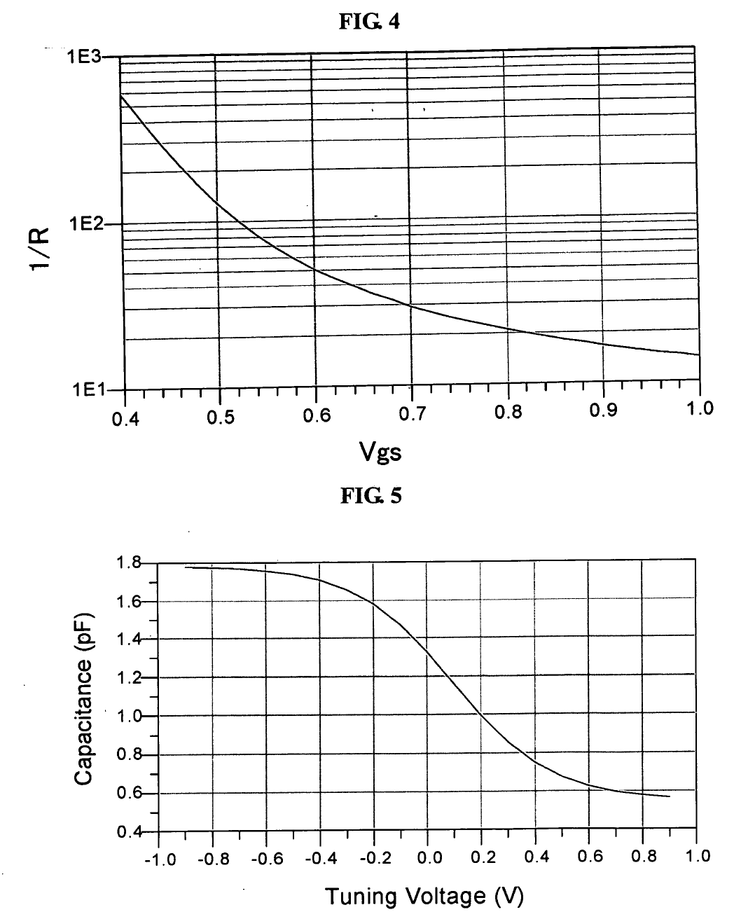

The first variable resistor VR1 according to an exemplary embodiment of the present invention may be formed with a single transistor. The single transistor receives a control signal as a gate voltage Vgs, from the phase frequency controller 310. As illustrated in FIG. 4, channel resistance varies according to the received gate voltage Vgs.

As described above, resistance of the first variable resistor VR1 according to an exemplary embodiment of the present invention may be varied by the varied channel resistance according to the gate voltage Vgs of the single transistor.

Accordingly, in the wideband polyphase filter 300 according to an exemplary embodiment of the present invention, the first variable resistor VR1 may operate at a high frequency by using a single transistor.

A first output end Q is connected at a connection point between the first variable resistor VR1 and the first variable capacitor VC1.

One side of the first capacitor VC1 is connected to the first variable resistor VR1 and the other side of the first capacitor VC 1 is connected to the second variable resistor VR2.

The first variable capacitor VC1 receives a control signal from the phase frequency controller 310 and varies capacitance according to the received control signal. In this instance, the control signal is for correcting a phase and frequency of the first variable capacitor VC1.

The first variable capacitor VC1 according to an exemplary embodiment of the present invention may be formed of a varactor. The varactor may be embodied as a MOS transistor. Also, the varactor receives a control signal as a control voltage, from the phase frequency controller 310. As illustrated in FIG. 5, capacitance is varied according to the received control signal.

An input end IN is connected at a connection point between the first variable capacitor VC1 and the second variable resistor VR2.

One side of the second variable resistor VR2 is connected to the first capacitor VC1 and the other side of the second variable resistor VR2 is connected to the second variable capacitor VC2.

The second variable capacitor VR2 receives a control signal from the phase frequency controller 310 and varies resistance according to the received control signal. In this instance, the control signal is for correcting a phase and frequency of the second variable resistor VR2.

The second variable resistor VR2 according to an exemplary embodiment of the present invention may be formed with a single transistor. The single transistor receives a control signal as a gate voltage Vgs, from the phase frequency controller 310. As illustrated in FIG. 4, channel resistance varies according to the received gate voltage Vgs.

Namely, the second variable resistor VR2 according to an exemplary embodiment of the present invention may be varied by the varied channel resistance according to the gate voltage Vgs of the signal transistor.

A second output end I is connected at a connection point between the second variable resistor VR2 and the second variable capacitor VC2.

One side of the second variable capacitor VC2 is connected to the second variable resistor VR2 and the other side of the second variable capacitor VC2 is connected to a ground.

The second variable capacitor VC2 receives a control signal as a control voltage, from the phase frequency controller 310 and varies capacitance according to the received control voltage. In this instance, the control signal is for correcting a phase and frequency of the second variable capacitor VC2.

The second variable capacitor VC2 may be formed with a varactor. The varactor may be embodied as a MOS transistor. Also, the varactor receives a control signal from the phase frequency controller 310. As illustrated in FIG. 5, capacitance is varied according to the received control signal.

As described above, the wideband polyphase filter 300 according to an exemplary embodiment of the present invention may receive a control signal outputted from the phase frequency controller 310. Also, the wideband polyphase filter 300 may vary resistance and capacitance according to the received control signal, so as to correct a phase error and frequency for wideband communication.

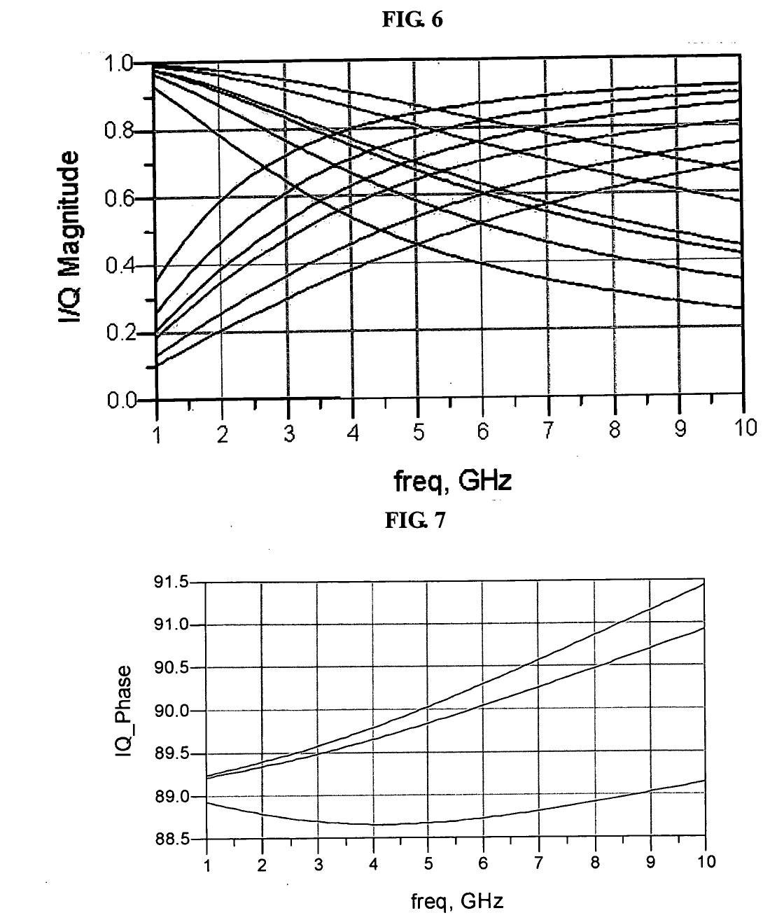

FIG. 6 is a diagram illustrating a relationship between an operating frequency and I/Q magnitude, in a wideband polyphase filter according to an exemplary embodiment of the present invention.

Referring to FIG. 6, the wideband polyphase filter 300 according to an exemplary embodiment of the present invention varies resistance and capacitance with the variable resistors and variable capacitors to correct a phase and frequency. Accordingly, the frequency tuning range is wide enough to cover the wideband frequency range between about 2.5 GHz and 9.5 GHz.

FIG. 7 is a diagram illustrating a relationship between an operating frequency and I/Q phase, in a wideband polyphase filter according to an exemplary embodiment of the present invention.

Referring to FIG. 7, an extremely small phase error within one degree relative to 90 degrees occurs in the wideband frequency range between 1 GHz and 10 GHz. Accordingly, the wideband polyphase filter 300 according to the exemplary embodiment of the present invention may easily correct the phase error.

A wideband polyphase filter according to the exemplary embodiment of present invention may vary resistance and capacitance, and correct a phase and frequency. Accordingly, a wideband frequency range may be obtained.

Also, a wideband polyphase filter according to the exemplary embodiment of the present invention may be formed with a minimum number of stages and may thereby reduce attenuation of an output signal.

Also, a wideband polyphase filter according to the exemplary embodiment of the present invention may correct I/Q phase error and gain mismatch.

Although a few exemplary embodiments of the present invention have been shown and described, the present invention is not limited to the described exemplary embodiments. Instead, it would be understood by those skilled in the art that changes may be made to these exemplary embodiments without departing from the principles and spirit of the invention, the scope of which is defined by the claims and their equivalents.

What is claimed is:

1. A wideband polyphase filter comprising:
a variable resistor which varies resistance; and
a variable capacitor which varies capacitance,
wherein the variable resistor and the variable capacitor correct a wideband frequency and a phase, convert a differential input into a quadrature signal and outputs the converted quadrature signal.

2. The wideband polyphase filter of claim 1, wherein the variable resistor and the variable capacitor are implemented in one of a single-stage and a multi-stage to tune the wideband frequency.

3. The wideband polyphase filter of claim 1, wherein the variable resistor is implemented with a single transistor.

4. The wideband polyphase filter of claim 1, wherein the variable capacitor is implemented with a varactor which has variable capacitance depending on a control voltage.

5. The wideband polyphase filter of claim 1,
wherein the variable resistor comprises a first variable resistor and a second variable resistor,
wherein the variable capacitor comprises a first variable capacitor and a second variable capacitor, and
wherein the variable resistor and the variable capacitor are connected to each other in order of the first variable resistor, the first variable capacitor, the second variable resistor and the second variable capacitor, an input end is connected at a connection point between the first variable capacitor and the second variable resistor, a first output end is connected at a connection point between the first variable resistor and the first variable capacitor, and a second output end is connected at a connection point between the second variable resistor and the second variable capacitor.
